(19) United States
(12) Patent Application Publication
(10) Pub. No.: US 2013/0154601 A1
(43) Pub. Date: Jun. 20, 2013

(54) REGULATOR TRANSIENT OVER-VOLTAGE PROTECTION

(71) Applicants: Kenneth P. Snowdon, Falmouth, ME (US); Hrvoje Jasa, Scarborough, ME (US)

(72) Inventors: Kenneth P. Snowdon, Falmouth, ME (US); Hrvoje Jasa, Scarborough, ME (US)

(21) Appl. No.: 13/331,321

(22) Filed: Dec. 20, 2011

(51) Int. Cl. G05F 3/02; H02H 9/04

(52) U.S. Cl. 323/311; 361/18

(57) ABSTRACT

This document discusses, among other things, apparatus and methods for providing over-voltage transient protection of a voltage regulator. In an example, an apparatus can include a first transistor including a control node and first and second switch nodes, and a low-pass filter configured to couple to the control node of the first transistor and to switch the first transistor to a first state when a voltage change of the supply voltage exceeds a threshold. The first transistor, in the first state, can be configured to couple a control node of a second transistor to the supply voltage to protect components coupled to a regulator transistor.

### BACKGROUND

Transient voltages on a voltage regulator supply can be transferred to the output of the regulator when the transient includes frequencies outside the control loop bandwidth of the regulator. Such transients can cause issues with device connected to the output of the regulator. Zener diodes can be employed in circuits to mitigate the effects of such transient voltages. For example, FIG. 1 illustrates generally a zener diode 101 configured to couple transient voltages from a voltage supply to a reference voltage of the supply, such as ground. FIG. 2 illustrates a zener diode 201 in a regulator drive circuit configured to turn off or limit the regulator output transistor upon receiving an input voltage V_{IN} over-voltage transient.

### OVERVIEW

In an example, low voltage electronics can be protected from high frequency, high-voltage transients that can flow through a voltage regulator using, among other things, an over-voltage transient protection circuit described herein and, in certain examples, including a low-pass filter and an over-voltage protection transistor. In an example, an over-voltage transient protection circuit can include a first transistor including a control node and first and second switch nodes, and a low-pass filter configured to couple to the control node of the first transistor and to switch the first transistor to a first state when a voltage change of the supply voltage exceeds a threshold. In certain examples, the first transistor, in the first state, can be configured to couple a control node of a second transistor to the supply voltage to protect components coupled to a regulator transistor.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIGS. 1 and 2 illustrate apparatus for reducing regulator output voltage effects of supply voltage transients.

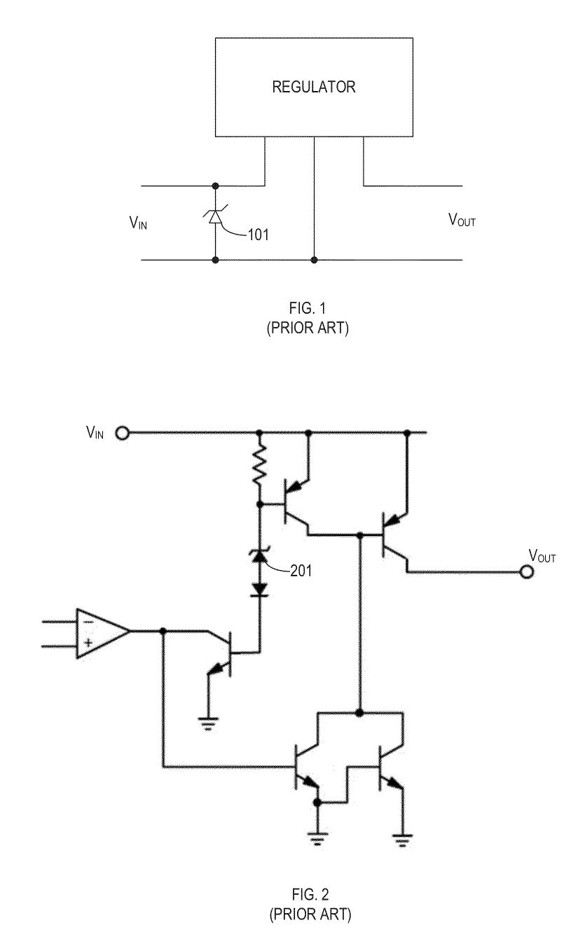

FIG. 3 illustrates generally an example voltage regulator signals including a supply voltage and a regulator output voltage for a regulator that does not have robust over-voltage transient protection.

FIG. 4 illustrates generally an example over-voltage protection circuit for a voltage regulator.

FIG. 5 illustrates generally voltage regulator signals including a supply voltage and a regulator output voltage for a regulator employing an example over-voltage protection circuit such as that illustrated in FIG. 2.

### DETAILED DESCRIPTION

Low voltage semiconductor technologies can allow devices to operate at very low supply voltages. Such technologies can provide increased energy efficiency while also using low voltage devices that can be economically more efficient to produce. Voltage regulators can be employed to transform higher supply voltages to the lower operating voltages. In certain examples, a regulator can use high voltage semiconductor devices (e.g., devices designed to operate using a 5 volt supply, etc.) to regulate a voltage for use by low voltage devices (e.g., devices designed to operate using a 1.8 volt supply, etc.). In general, low voltage devices cannot be used to regulate the higher voltages because the higher voltages, or transients associated with the supply voltages, can damage the low voltage devices, such as low voltage oxides used in low voltage transistors.

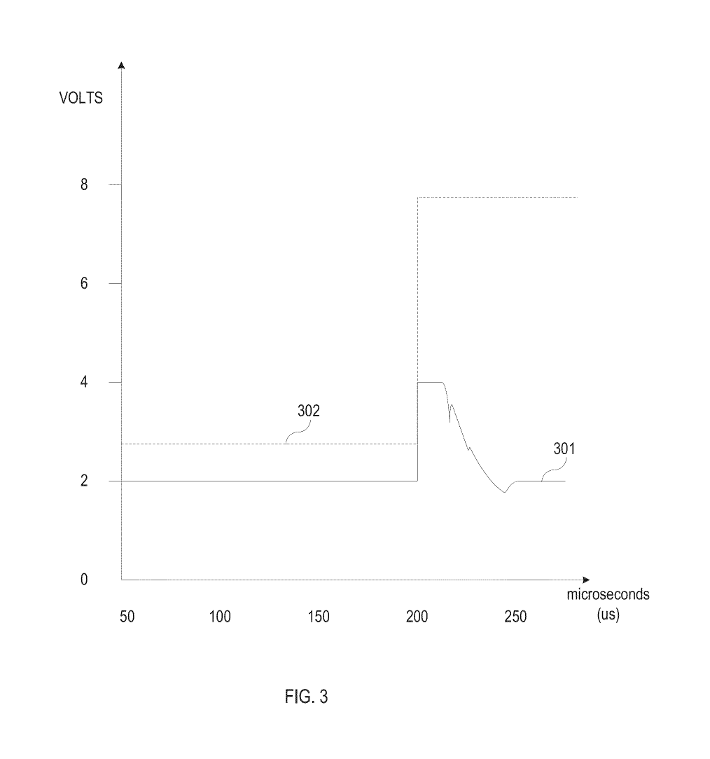

FIG. 3 illustrates generally voltage regulator signals including a supply voltage 301 and a regulator output voltage 302 for a regulator that does not have robust over-voltage transient protection. The regulator can be designed to provide a regulator output voltage 102 of about 2 volts. In an example, the supply voltage 301 can initially be about 2.7 volts until about 200 microseconds. At about 200 microseconds, the supply voltage 301 increases quickly, for example, within 5 nanoseconds, to about 7.7 volts. In response to the increase of the supply voltage 301 from about 2.7 volts to about 7.7 volts, the regulator output voltage 302 substantially follows the increase to about 4 volts before being clamped and then being controlled by the regulator to the desired voltage (e.g., 2 volts) at about 235 microseconds. Low voltage devices, such as transistors designed to operate using a nominal 1.8 volt supply, can sustain damage if a transient voltage of about 4 volts is applied to the device.

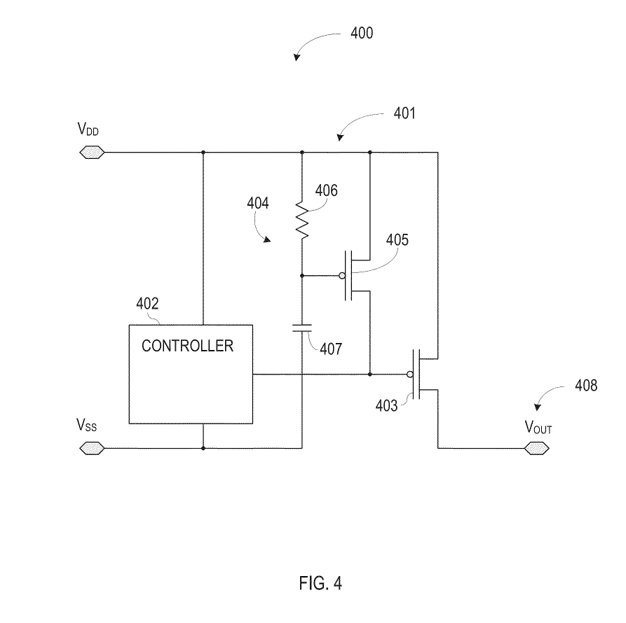

FIG. 4 illustrates generally an example over-voltage transient protection circuit 401 for a voltage regulator 400. In certain examples, the regulator 400 can include a controller 402 and one or more output or regulator transistors 403. The controller 402 can drive the gate of the output transistor 403 to maintain a desired nominal voltage V_{OUT} at an output 408 of the regulator 400 using an available supply voltage V_{DD}. In certain examples, the over-voltage transient protection circuit 401 can receive the supply voltage V_{DD}, can detect a high frequency transient of the supply voltage V_{DD}, and can provide an overriding command signal to the gate of the output transistor 403 that prevents the output transistor 403 from coupling the supply voltage V_{DD} to the output 408. In certain examples, the overriding command signal can reduce damage to low voltage components coupled to the output transistor 403 by isolating transients of the supply voltage V_{DD} from the output 408.

In an example, the over-voltage transient protection circuit 401 can include a low-pass filter 204, such as a resistor-capacitor (RC) network including a resistor 406 and a capacitor 407, coupled to a gate of an over-voltage protection transistor 405. In an example, the resistor 406 of the low-pass filter 404 can be coupled to the supply voltage V_{DD} and the capacitor 407 of the low-pass filter 404 can be coupled in series with the resistor 406 and a second supply voltage V_{SS}, such as a reference voltage or ground.

In an example, the capacitor 407 can charge to the supply voltage V_{DD} and maintain the over-voltage protection transistor 405 in a high impedance state such that the gate of the output transistor 403 is isolated from the supply voltage V_{DD}. When a voltage transient is received on the supply voltage V_{DD}, the voltage across the capacitor 407 can change according to the time constant associated with the low-pass filter 404. For high frequency transients, such as those outside the bandwidth of the controller 202, the low-pass filter 404 can be configured such that the voltage across the capacitor 407 can rise slower than the transient voltage rise. In an example, a source of the over-voltage protection transistor 405 can track with the supply voltage V_{DD} as the high-speed transition of the supply voltage V_{DD} occurs. The slower rise of the voltage at the gate of the over-voltage protection transistor 405, due to the low-pass filter 404, can produce a high enough gate-to-source voltage (V_{gs}) that the over-voltage protection transistor 405 can begin to conduct and to couple the gate of the output transistor 403 to the supply voltage V_{DD}.

In an example, coupling the output transistor 403, such as a PMOS output transistor, to the supply voltage can turn the output transistor 403 “off” (e.g., a high impedance state) and force the output transistor 403 “off”. When off, the output 408 of the regulator 400 can be isolated from the supply voltage V_{DD}, including voltage transients of the supply voltage V_{DD}. Thus, the slower rise of the voltage of the capacitor 407 can turn the over-voltage protection transistor 405 “on” (e.g., a low impedance state) causing a low impedance path between the supply voltage V_{DD} and the gate of the output transistor 403. In an example, the low impedance path can prevent the output transistor 403 from being “on” and can isolate the output 408 of the regulator from the supply voltage V_{DD}, including voltage transients of the supply voltage V_{DD}.

The low impedance path between the gate of the output transistor 403 and the supply voltage V_{DD} can over-ride output command signals of the controller 402. In an example, the low impedance path can turn the output transistor 403 “off”, thus isolating the supply voltage V_{DD} from the output 408 of the regulator V_{OUT} until the capacitor 407 sufficiently charges to turn “off” the over-voltage protection transistor 405. The delay caused by the charging of the capacitor 407 can be long enough to allow the controller 402 to adjust the gate drive of the output transistor 403 to the new input supply voltage V_{DD}.

In various examples, the characteristics of the low-pass filter 404 (e.g., time constants, cutoff frequencies, etc.) can be set by a user, such as by selecting components that provide a specified time constant, etc., can be adjustable, such as by using adjustable components, etc., or can be programmable, such as by using the controller 402, etc.

In certain examples, an integrated circuit can include the low-pass filter 404 and the over-voltage protection transistor 405. In an example, an integrated circuit can include the controller 402 and the over-voltage transient protection circuit 401.

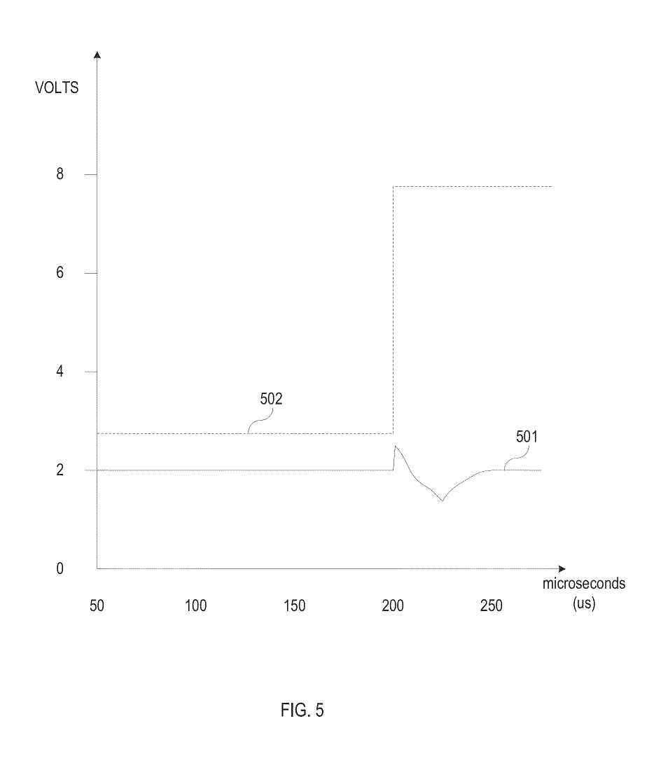

FIG. 5 illustrates generally voltage regulator signals including a supply voltage 501 and a regulator output voltage 502 for a regulator employing an example over-voltage protection circuit, such as that illustrated in FIG. 4. The regulator can be designed to provide a regulator output voltage 502 of about 2 volts. The supply voltage 501 is initially about 2.7 volts until about 200 microseconds. At about 200 microseconds, the supply voltage 501 increases quickly, for example, within 5 nanoseconds, to about 7.7 volts. In response to the increase of the supply voltage 501 from about 2.7 volts to about 7.7 volts, the regulator output voltage 502 substantially follows the increase to about 2.5 volts. As the supply voltage increases, the low pass filter delays the rise in voltage of the gate of the over-voltage protection transistor, such as by charging a capacitor of the low pass filter. As the supply voltage continues to climb, the over-voltage protection transistor turns “on”. because of the voltage difference between the gate and the source. The on-state of the over-voltage protection transistor can create a low impedance path between the supply voltage and the gate of the output transistor. The low impedance path can raise the voltage on the gate of the output transistor and can keep the output transistor “off”, thus, isolating the output voltage 502 from the supply voltage 501. When the low pass filter allows the gate of the over-voltage protection transistor to rise, the over-voltage protection transistor can turn “off”, thus releasing control of the output transistor to the regulator controller. In certain examples, the control delay created by the over-voltage transient protection circuit can allow the regulator controller to adjust to the level of the input voltage while isolating the output voltage from the aggressive change of the input voltage transient. The voltages described above with respect to the voltage regulator are for purposes of illustration and are not to be construed as limiting the present subject matter. It is understood that other regulator supply voltages and output voltages are possible without departing from scope of the present subject matter.

### ADDITIONAL NOTES & EXAMPLES

In Example 1, a system can include a first transistor, a second transistor, and a low-pass filter, wherein the first transistor is configured to detect a voltage transient using the low-pass filter and to turn off the second transistor to protect components coupled to the second transistor from the voltage transient.

In Example 2, the first transistor of Example 1 optionally includes a control node and is configured to receive a supply voltage at the control node through the low-pass filter.

In Example 3, the second transistor of any one or more of Examples 1-2 optionally is configured to receive the supply voltage through the first transistor when the first transistor detects the voltage transient using the low-pass filter.

In Example 4, the system of any one or more of Examples 1-3 optionally includes low voltage components configured to receive a regulated voltage from the second transistor, wherein the first transistor and the low-pass filter are configured to protect the low voltage components from the voltage transient.

In Example 5, the voltage transient of any one or more of Examples 1-4 optionally includes a supply voltage increase above a loop bandwidth of a voltage regulator including the second transistor.

In Example 6, the second transistor of any one or more of Examples 1-5 optionally includes an output transistor of a regulator circuit, and wherein voltage transient includes a supply voltage increase above a loop bandwidth of the regulator circuit.

In Example 7, the first transistor of any one or more of Examples 1-6 optionally includes a control node and first and second switch nodes, wherein the first switch node is configured to couple to a supply voltage.

In Example 8, the second switch node of any one or more of Example 1-7 optionally is configured to be coupled to a control node of the second transistor.

In Example 9, the low-pass filter of any one or more of Examples 1-8 optionally includes a resistor-capacitor (RC) network.

In Example 10, the control node of the first transistor of any one or more of Examples 1-9 optionally is coupled directly to a capacitor of the RC network.

In Example 11, the capacitor of any one or more of Examples 1-10 optionally is coupled directly to ground.

In Example 12, a resistor of the RC network of any one or more of Example 1-11 optionally is coupled between the control node of the first transistor and the supply voltage.

In Example 13, the first transistor of any one or more of Examples 1-12 optionally includes a PMOS transistor and the second transistor of any one or more of Examples 1-12 optionally includes a PMOS transistor.

In Example 14, a method can include detecting a voltage transient using a first transistor and a resistor capacitor (RC) network, and turning off a second transistor to protect components coupled to the second transistor from the voltage transient.

In example 15, the detecting a voltage transient of any one or more of Examples 1-14 optionally includes detecting a voltage transient of a supply voltage using the first transistor and the resistor capacitor (RC) network.

In Example 16, the detecting a voltage transient of any one or more of Examples 1-15 optionally includes delaying a response of the control node of the first transistor from following the voltage transient using a capacitor of the RC network.

In Example 17, the turning off the second transistor of any one or more of Examples 1-16 optionally includes switching the first transistor to an on-state using the delayed response of the control node of the first transistor to the transient voltage.

In Example 18, the turning off the second transistor of any one or more of Examples 1-17 optionally includes coupling a control node of the second transistor to the voltage source using the on-state of the first transistor.

In Example 19, an apparatus can include a first transistor including a control node and first and second switch nodes, the first switch node configured to receive a supply voltage, the second switch node configured to couple to a control node of a second transistor, the first transistor, in a first state, configured to couple the control node of the second transistor to the supply voltage to protect components coupled to the regulator transistor, and a low-pass filter configured to couple to the control node of the first transistor and to switch the first transistor to the first state when a voltage change of the supply voltage exceeds a threshold.

In Example 20, the first transistor of any one or more of Examples 1-19 optionally includes a PMOS transistor and the second transistor of any one or more of Examples 1-19 optionally includes a PMOS transistor.

In Example 21, an integrated circuit optionally includes the first transistor and the low-pass filter of any one or more of examples 1-20.

In Example 22, the low-pass filter of any one or more of Examples 1-21 optionally includes a resistor-capacitor (RC) network.

In Example 23, a voltage regulator can include a regulator transistor configured to receive a supply voltage and provide a regulated output voltage, a regulator controller configured to control the regulator transistor, a protection circuit configured to detect a transient voltage within the supply voltage and to maintain the regulator transistor in an off-state during the voltage transient. The protection circuit can include a first transistor, and a resistor-capacitor (RC) network. The first transistor can be configured to detect a voltage transient using the RC network and to maintain the regulator transistor on an off-state to protect components coupled to the second transistor from the voltage transient. The first transistor can include a control node and can be configured to receive the supply voltage at the control node through the RC network. The control node of the first transistor can be coupled directly to a capacitor of the RC network. The first transistor can include first and second switch nodes, the first switch node configured to couple to the supply voltage, and the second switch node configured to couple to a control node of the regulator transistor. The regulator transistor can be configured to receive the supply voltage through the first transistor when the first transistor detects the voltage transient using the RC network. The voltage transient can include a supply voltage increase above a loop bandwidth of the voltage regulator.

In Example 24, an integrated circuit optionally includes the regulator controller and the protection circuit of any one or more of Examples 1-23.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. A system comprising:
a first transistor;
a second transistor; and
a low-pass filter;
wherein the first transistor is configured to detect a voltage transient using the low-pass filter and to turn off the second transistor to protect components coupled to the second transistor from the voltage transient.

2. The system of claim 1, wherein the first transistor includes a control node and is configured to receive a supply voltage at the control node through the low-pass filter.

3. The system of claim 2, wherein the second transistor is configured to receive the supply voltage through the first transistor when the first transistor detects the voltage transient using the low-pass filter.

4. The system of claim 1, including low voltage components configured to receive a regulated voltage from the second transistor, wherein the first transistor and the low-pass filter are configured to protect the low voltage components from the voltage transient.

5. The system of claim 1, wherein the voltage transient includes a supply voltage increase above a loop bandwidth of a voltage regulator including the second transistor.

6. The system of claim 1, wherein the second transistor includes an output transistor of a regulator circuit, and wherein voltage transient includes a supply voltage increase above a loop bandwidth of the regulator circuit.

7. The system of claim 1, wherein the first transistor includes a control node and first and second switch nodes; and
wherein the first switch node is configured to couple to a supply voltage.

8. The system of claim 7, wherein the second switch node is configured to be coupled to a control node of the second transistor.

9. The system of claim 7, wherein the low-pass filter includes a resistor-capacitor (RC) network.

10. The system of claim 9, wherein the control node of the first transistor is coupled directly to a capacitor of the RC network.

11. The system of claim 10, wherein the capacitor is coupled directly to ground.

12. The system of claim 11, wherein a resistor of the RC network is coupled between the control node of the first transistor and the supply voltage.

13. The system of claim 1, wherein the first transistor includes a PMOS transistor and wherein the second transistor includes a PMOS transistor.

14. A method comprising:
detecting a voltage transient using a first transistor and a resistor capacitor (RC) network; and
turning off a second transistor to protect components coupled to the second transistor from the voltage transient.

15. The method of claim 14, wherein detecting a voltage transient includes detecting a voltage transient of a supply voltage using the first transistor and the resistor capacitor (RC) network.

16. The method of claim 14, wherein detecting a voltage transient includes delaying a response of the control node of the first transistor from following the voltage transient using a capacitor of the RC network.

17. The method claim 16, wherein turning off the second transistor includes switching the first transistor to an on-state using the delayed response of the control node of the first transistor to the transient voltage.

18. The method of claim 17, wherein turning off the second transistor includes coupling a control node of the second transistor to the voltage source using the on-state of the first transistor.

19. An apparatus comprising:
a first transistor including a control node and first and second switch nodes, the first switch node configured to receive a supply voltage, the second switch node configured to couple to a control node of a second transistor, the first transistor, in a first state, configured to couple the control node of the second transistor to the supply voltage to protect components coupled to the regulator transistor; and
a low-pass filter configured to couple to the control node of the first transistor and to switch the first transistor to the first state when a voltage change of the supply voltage exceeds a threshold.

20. The apparatus of claim 19, wherein the first transistor includes a PMOS transistor and wherein the second transistor includes a PMOS transistor.

21. The apparatus of claim 19, wherein an integrated circuit includes the first transistor and the low-pass filter.

22. The apparatus of claim 19, wherein the low-pass filter includes a resistor-capacitor (RC) network.

23. A voltage regulator comprising:
a regulator transistor configured to receive a supply voltage and provide a regulated output voltage;
a regulator controller configured to control the regulator transistor;
a protection circuit configured to detect a transient voltage within the supply voltage and to maintain the regulator transistor in an off-state during the voltage transient,
wherein the protection circuit includes:
a first transistor; and
a resistor-capacitor (RC) network;
wherein the first transistor is configured to detect a voltage transient using the RC network and to maintain the regulator transistor on an off-state to protect components coupled to the second transistor from the voltage transient;
wherein the first transistor includes a control node and is configured to receive the supply voltage at the control node through the RC network;
wherein the control node of the first transistor is coupled directly to a capacitor of the RC network;
wherein the first transistor includes first and second switch nodes, the first switch node configured to couple to the supply voltage, and the second switch node configured to couple to a control node of the regulator transistor;
wherein the regulator transistor is configured to receive the supply voltage through the first transistor when the first transistor detects the voltage transient using the RC network;
wherein the voltage transient includes a supply voltage increase above a loop bandwidth of the voltage regulator.

24. The voltage regulator of claim 22, wherein an integrated circuit includes the regulator controller and the protection circuit.
